(19) United States
(12) Patent Application Publication
(10) Pub. No.: US 2010/0039395 A1
(43) Pub. Date: Feb. 18, 2010

(54) Touch Screen

(76) Inventors: Juha H.P. Nurmi, Salo (FI); Kaj Saarinen, Tokyo (JP)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/225,528

(22) PCT Filed: Mar. 23, 2006
(86) PCT No.: PCT/FI2006/050110

§ 371 Date: Oct. 7, 2009

(51) Int. Cl. G06F 3/041

(52) U.S. Cl. 345/173

(57) ABSTRACT

The invention relates to a user interface module comprising at least a first information element and a sensor element that is adjusted to sense the location of a touching means when the touching means is in the vicinity of the first information element. The module also comprises a second information element and said sensor element is adjusted to sense the location of the touching means when the touching means is in the vicinity of the second information element. The invention also relates to a device comprising a user interface module and a method for sensing control pointing in a device.

### FIELD OF THE INVENTION

The present invention relates to touch screens. The invention relates to a user interface module. Furthermore, the invention relates to a device a, as well as a method for sensing control pointing in a device.

### BACKGROUND OF THE INVENTION

Different kinds of methods have been invented for completing the initial process of digitization of information using various computer peripherals. For example, among the various keyboard input methods, such as speech recording input, graphics collection, etc., the most effective and most convenient one is to perform input of information or command directly on a display screen by means of a method such as touching-pointing. For example, a PDA basically does not have key operation, but it rather uses touch control pen operation of a touch screen entirely to complete the various operations.

A touch screen is a device placed over or above a display which provides a signal when the screen is mechanically touched. There are a variety of detection methods used including capacitive, surface acoustic wave, infrared, inductive, and resistive methods.

The existing touch control panel mainly uses an electrical resistance type method. Resistive touch screens have a conductive coating deposited upon the substrate and a conductive, flexible cover sheet placed over the substrate that is indented by a stylus or finger to create an electrical connection between the conductive flexible cover and the conductive substrate. In a concrete configuration thereof, a transparent touch membrane is provided on the outside of the display screen, and an electrical resistance layer is applied on the surface of the touch membrane; when an operation indicates a specific location on the touch membrane, a subsequently connected recognition and control circuit acquires knowledge through computation of a change of electrical potential of that location, and determines the coordinates of the indicated location, whereby the corresponding operation is executed.

Foldable phones (sometimes called clamshell-type phones) are often equipped with two displays: a large-sized first display for use mainly in an open-folded position and a smaller second display for use mainly in a closed-folded position. Some of the foldable mobile phones have a main display provided inside of an upper housing, and a sub-display provided on the top surface of an upper housing, and a hinge that enables the upper housing and the lower housing to open/close so as to cover the respective top surfaces of each other.

Supplying the device with a second display makes the mobile device thicker and also causes additional expenses. The overall complexity of the device increases significantly and this raises several mechanical and electrical issues.

This invention solves a problem of using a touch screen for two display modules without increasing the number of components as well as reducing the thickness of the two display modules

### SUMMARY OF THE INVENTION

Now, a solution has been invented, which enables the implementation of a mechanically simple user interface module with two information panels.

To attain this purpose, the user interface module comprises at least a first information element and a sensor element that is adjusted to sense the location of a touching means when the touching means is in the vicinity of the first information element, wherein the module also comprises a second information element and said sensor element is adjusted to sense the location of the touching means when the touching means is in the vicinity of the second information element. The device according to the invention, in turn, comprises at least a user interface module that comprises at least a first means for presenting information and a means for sensing control pointing that is adjusted to sense the location of a touching means when the touching means is in the vicinity of the first means for presenting information, wherein the module also comprises a second means for presenting information and said means for sensing control pointing is adjusted to sense the location of the touching means when the touching means is in the vicinity of the second means for presenting information. The method for sensing control pointing in a device that comprises at least a first information element and a sensor element, which senses the location of a touching means when the touching means is in the vicinity of the first information element, wherein the module also comprises a second information element and said sensor element senses the location of the touching means when the touching means is in the vicinity of the second information element.

The user interface module according to the invention is primarily characterized in that the module comprises a first information element and a second information element, and one sensor element is adjusted to sense the location of a touching means when the touching means is in the vicinity of the first information element and/or in the vicinity of the second information element.

A main idea of the invention is that only one sensor element, for example a touch screen, is used, for two information elements. The information element can be, for example, a display module, a keyboard module, an image etc.

In one embodiment the first information element is a main display and the second information element is a sub-display. In another embodiment the first information element is a display and the second information element is a permanent image, as for example a surface of a keyboard.

It is possible to produce a double-sided user interface component. In one embodiment the operation side of the first information element is directed to a different direction than the operation side of the second information element. The operation side of the information element is the side that is operable by the user when the user interface module is installed. The operation could be, for example, touching or looking.

In one embodiment the backside of the first information element is directed against the backside of the second information element. The backside is the opposite side from the operation side of the information element. In one embodiment the sensor element is between the backsides. In other words, in this construction there is a dual-sided user interface module where the first side and the second side are substantially parallel.

In one embodiment the sensor element is an inductive sensor element. When the sensor is behind the information element, the information element (for example display) is not obscured at all by the sensor element. In addition the sensor element is better protected.

The different embodiments of the invention offer several advantages over solutions of prior art. Depending on the implementation manner of the embodiment, the invention may provide, for example, one or more of the following advantages:
only one sensor element in the user interface component
a slimmer solution
reduced thickness of the combo display modules case
a solution with lower costs
reduced electrical interference

### DESCRIPTION OF THE DRAWINGS

The above and other objects, features and advantages of the present invention will become more apparent from the following detailed description when taken in conjunction with the accompanying drawings in which:

FIG. 1 illustrates a cross-section of a touch sensitive module according to an embodiment of the present invention,

FIG. 2 shows a device where the touch sensitive module has been installed in the open position,

FIG. 3 illustrates a cross-section of the device according to FIG. 2 from line A-A,

FIG. 4 shows the device according to FIG. 2 in the closed position,

FIG. 5 illustrates a cross-section of the device according to FIG. 4 from line B-B,

FIGS. 6 and 7 show another device where the touch sensitive module has been installed,

FIG. 8 illustrates a cross-section of the device according to FIGS. 6 and 7 from line C-C,

FIGS. 9 and 10 show another device where the touch sensitive module has been installed, and

FIG. 11 illustrates a cross-section of the device according to FIG. 10 from line D-D.

For the sake of clarity, the figures only show the details necessary for understanding the invention. The structures and details which are not necessary for understanding the invention and which are obvious to anyone skilled in the art have been omitted from the figures in order to emphasize the essential characteristics of the invention.

### DETAILED DESCRIPTION OF THE INVENTION

In this description an inductive sensor element is used as an example of a sensor element. The sensor element could also be some other kind than an inductive sensor, for example, an optical sensor element.

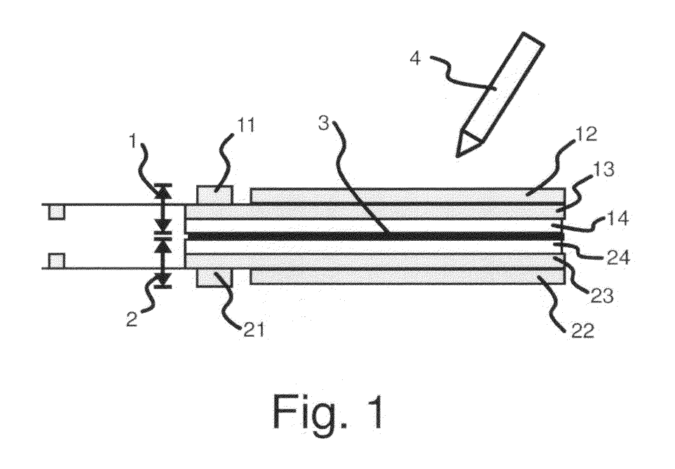

FIG. 1 shows one embodiment of the touch sensitive user interface module. There are first and second means for presenting information, such as the first information element 1 and the second information element 2. Between those panels 1, 2 there is a means for sensing control pointing, such as a sensor element 3. The sensor element 3 is shared by the first information element 1 and for the second information element 2. The sensor element 3 detects the touches and/or the distance of the touching means 4.

The information element 1, 2 (or information panel) can be, for example, a display, an image or some other structure, which contains some kind of information. Information can be visual or it can be touchable (for example, some kind of elevations and/or hollows). In addition the information can be permanent or non-permanent (as a “typical” display). In the embodiment shown in FIG. 1, there are two displays 1, 2 and display drivers 11, 21 are also shown. The display driver 11, 21 controls the operation of the display 1, 2. In this embodiment the display 1, 2 comprises display glasses 12, 13, 22, 23 and a light guide 14, 24. It is possible to produce the display in many ways.

In one embodiment the touching means 4 is a stylus and an inductive stylus sensing method is used. The inductive pen sensing method is in many cases more accurate than, for example, the current method.

It is also possible to use different kinds of sensor structures as the sensor element 3. The sensor element 3 is a touch screen in one embodiment.

In one embodiment the sensor element 3 is an inductive sensor element. The inductive sensor does not need a direct touch of the touching means 4. The inductive sensor can detect a stylus at a distance of up to 10 to 20 mm. Therefore, it is possible to adjust the inductive sensor element 3 between the information elements 1, 2. Because the inductive sensor does not require the multiple layers of a touch screen, the module (and later devices) can be thinner.

In this description the terms operation side and backside of the information element 1, 2 are used. The operation side of the information element 1, 2 is the side that is operable by the user when the user interface module is installed. The operation could be, for example, touching or looking. The backside is the opposite side from the operation side of the information element 1, 2.

In one embodiment the operation side of the first information element 1 is directed to a different direction than the operation side of the second information element 2. In other words, it is possible to produce a double-sided user interface component.

In one embodiment the backside of the first information element 1 is directed against the backside of the second information element 2. In other words, in this construction there is a dual-sided user interface module where the first side and the second side are substantially parallel. In one embodiment the sensor element 3 is between the backsides.

The sensor element 3 can also be used in many ways. In one embodiment the sensor element 3 indicates the distance of the stylus 4. In one embodiment the sensor element 3 indicates key pressures of the keyboard.

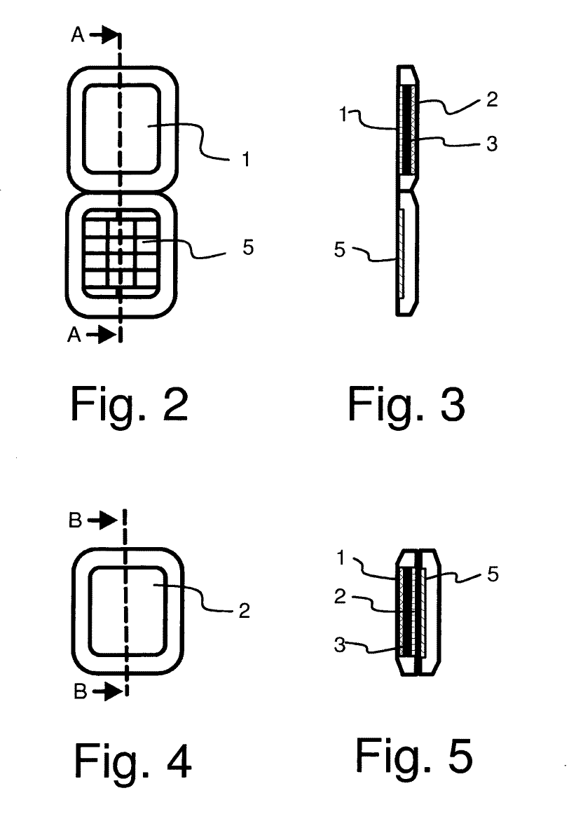

FIGS. 2 to 5 show an example where the first information element 1 is a main display and the second information element 2 is a sub-display. The operation sides of these displays 1, 2 are substantially on opposite sides of the module. FIG. 2 shows the device in the position when the main display 1 is in view. FIG. 3 illustrates a cross-section of the device according to FIG. 2 from line A-A. FIG. 4, in turn, shows the device in the position when the sub display 2 is in view. FIG. 5 illustrates a cross-section of the device according to FIG. 4 from line B-B. In this example the device is a foldable device, and in FIG. 2 the device is in the open position and in FIG. 4 the device is in the closed position. There may also be other control means in the device, such as a keyboard 5, a loudspeaker, a microphone etc.

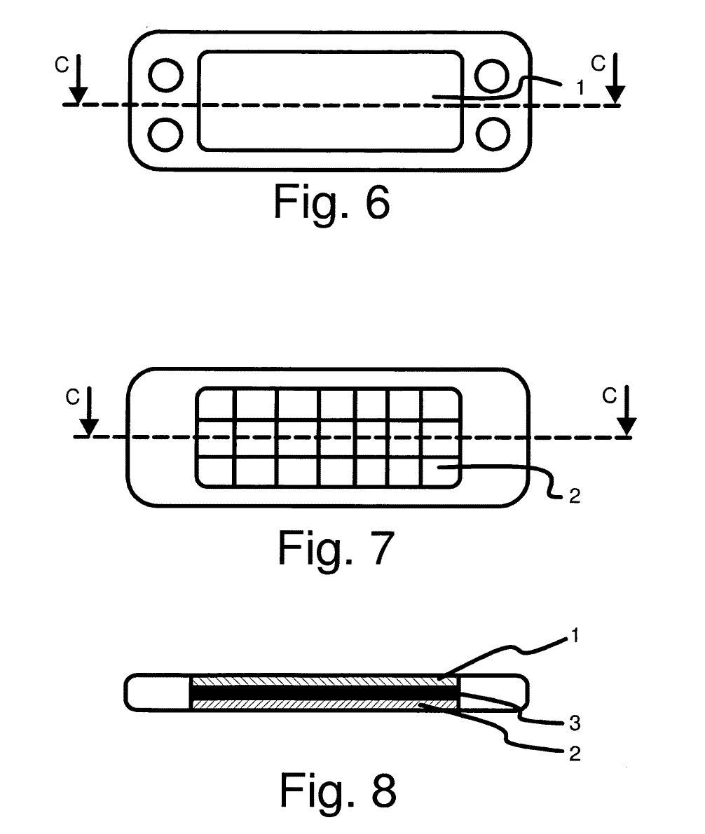

FIGS. 6, 7 and 8, in turn, show an example, where the first information element 1 is a display and the second information element 2 is a surface of a keyboard (as a permanent image). FIG. 6 shows the device in the position when the display 1 is in view. FIG. 7, in turn, shows the device in the position when the keyboard 2 is in view. FIG. 8 illustrates a cross-section of the device according to FIGS. 6 and 7 from line C-C. In this example the device is a console-type device.

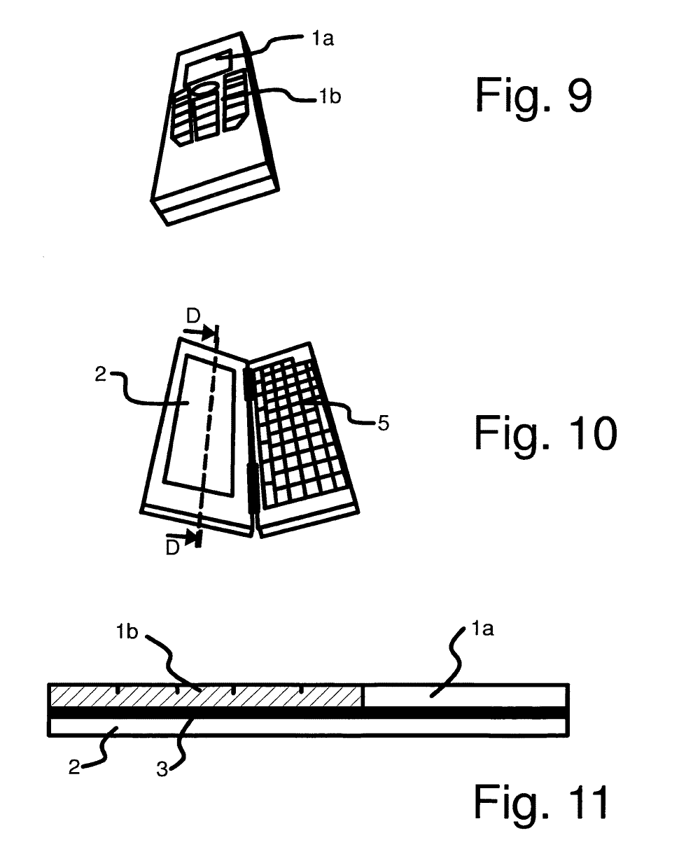

FIGS. 9, 10 and 11 show an example, where a part 1a of the first information element 1 is used as a display and the rest 1b of the first information element 1 is used as a keyboard. FIG. 9 shows the device in the position when the first information element 1 is in view. FIG. 10, in turn, shows the device in the position when the second information element 2 is in view. FIG. 11 illustrates a cross-section of the touch sensitive user interface module according to FIG. 10 from line D-D. As can be seen from these figures, the touch sensitive module comprises a first information element 1 and a second information element 2 and a sensor element 3. The first information element 1 comprises a first area 1a and a second area 1b. The first area 1a is used as a display and the second area 1b is used as a keyboard.

The identification of the information element 1, 2 in use can be done in many ways. In one embodiment the sensor element 3 has been adjusted to recognise the information element 1, 2 in use. In another embodiment the position of the housing of the foldable device is recognised and this information is used to control the identification of the information element 1, 2 in use.

The touch sensitive user interface module is suitable in many solutions. Perhaps the module is most advantageous in mobile devices, where the thin structure is advantageous. The touch sensitive user interface module may also be useful in thin devices with many user interface areas. Some typical devices are, for example, mobile phones, PDAs, cameras, consoles, etc.

By combining the modes and structures presented in connection with the different embodiments of the invention presented above, it is possible to provide various embodiments of the invention in accordance with the spirit of the invention. Therefore, the above-presented examples must not be interpreted as restrictive to the invention, but the embodiments of the invention can be freely varied within the scope of the inventive features presented in the claims hereinbelow.

1. A user interface module comprising at least a first information element and a sensor element that is adjusted to sense the location of a touching means when the touching means is in the vicinity of the first information element,
wherein the module also comprises a second information element and said sensor element is adjusted to sense the location of the touching means when the touching means is in the vicinity of the second information element.

2. The user interface module according to claim 1, wherein the first information element is a display.

3. The user interface module according to claim 1, wherein the second information element is a keyboard.

4. The user interface module according to claim 1, wherein the first information element comprises a display and a keyboard.

5. The user interface module according to claim 1, wherein the sensor element is an inductive sensor element.

6. The user interface module according to claim 1, wherein the information element has an operation side and a backside and in the module the backside of the first information element is directed against the backside of the second information element.

7. The user interface module according to claim 6, wherein the operation side of the first information element and the operation side of the second information element are substantially parallel.

8. A device comprising at least a user interface module that comprises at least a first means for presenting information and a means for sensing control pointing that is adjusted to sense the location of a touching means when the touching means is in the vicinity of the first means for presenting information,
wherein the module also comprises a second means for presenting information and said means for sensing control pointing is adjusted to sense the location of the touching means when the touching means is in the vicinity of the second means for presenting information.

9. The device according to claim 8, wherein the means for presenting information is a display.

10. The device according to claim 8, wherein the second means for presenting information is a keyboard.

11. The device according to claim 8, wherein the means for presenting information comprises a display and a keyboard.

12. The device according to claim 8, wherein the means for sensing control pointing is an inductive sensor element.

13. The device according to claim 8, wherein the means for presenting information has an operation side and a backside and in the module the backside of the first means for presenting information is directed against the backside of the second means for presenting information.

14. The device according to claim 13, wherein the operation side of the first means for presenting information and the operation side of the second means for presenting information are substantially parallel.

15. A method for sensing control pointing in a device that comprises at least a first information element and a sensor element, which senses the location of a touching means when the touching means is in the vicinity of the first information element,
wherein the module also comprises a second information element and said sensor element senses the location of the touching means when the touching means is in the vicinity of the second information element.

16. The method according to claim 13, wherein the first information element is a display.

17. The method according to claim 15, wherein the second information element is a keyboard.

18. The method according to claim 15, wherein the sensor element is an inductive sensor element.

19. The method according to claim 15, wherein the information element has an operation side and a backside and in the module the backside of the first information element is directed against the backside of the second information element.

20. The method according to claim 19, wherein the operation side of the first information element and the operation side of the second information element are substantially parallel.
